(19) United States
(12) Patent Application Publication
(10) Pub. No.: US 2013/0314780 A1
(43) Pub. Date: Nov. 28, 2013

(54) LENS DESIGNS FOR INTEGRAL IMAGING 3D DISPLAYS

(71) Applicants: Charles A. Marttila, Shoreview, MN (US); Manoj Nirmal, Saint Paul, MN (US); Erik A. Aho, North Saint Paul, MN (US); Eileen M Haus, Saint Paul, MN (US)

(72) Inventors: Charles A. Marttila, Shoreview, MN (US); Manoj Nirmal, Saint Paul, MN (US); Erik A. Aho, North Saint Paul, MN (US); Eileen M Haus, Saint Paul, MN (US)

(73) Assignee: 3M Innovative Properties Company

(21) Appl. No.: 13/480,674

(22) Filed: May 25, 2012

(51) Int. Cl. G02B 27/22

(52) U.S. Cl. CPC G02B 27/2214
USPC 359/463

(57) ABSTRACT

Integral imaging 3D films for use with a display panel. The films include a flexible transmissive substrate having a first surface on a viewer side and a second surface for placement on the display panel. Convex lenses are located on the first surface. The second surface is planar for a plano-convex design or has concave lenses registered with the convex lenses for a convex-concave compound lens design. In the plano-convex design, the lens focus is in front of or behind the pixels. In the convex-concave design, the convex and concave lenses combined focus is in front of, at, or behind the pixels. In use the 3D films produce 3D images with motion parallax.

### BACKGROUND

Integral imaging is a glasses-free three-dimensional (3D) technology platform that can be developed into displays for mobile phones, tablets, large format televisions as well as static 3D posters. It enables objects to be viewed in true 3D with motion parallax. As in the real world, one can look around an object, and objects move relative to each other as the viewer changes position. These features are not available in current generation stereoscopic 3D displays, and integral imaging is regarded by some manufacturers as a next generation 3D display technology. Accordingly, a need exists for integral imaging 3D solutions that provide for motion parallax.

### SUMMARY

A first integral imaging 3D article, consistent with the present invention, includes a transmissive substrate having a first surface with a plurality of convex lenses and a second surface opposite the first surface. The lenses are configured such that, when the second surface is placed on a display panel having pixels, the lens focus is in front of or behind the pixels.

A second integral imaging 3D article, consistent with the present invention, includes a transmissive substrate having a first surface and a second surface opposite the first surface. A plurality of convex lenses are located on the first surface of the substrate, and a plurality of concave lenses are located on the second surface of the substrate and registered with the convex lenses. The convex and concave lenses are configured such that, when the second surface is placed on a display panel having pixels, the convex and concave lenses combined focus is in front of, at, or behind the pixels.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram illustrating integral imaging 3D technology;

FIG. 2 is a diagram of an integral imaging 3D lens with eight views for a full pixel design;

FIG. 3 is a side view of a plano-convex 3D lens for a full pixel design;

FIG. 4 is a perspective view of a model of the lens of FIG. 3;

FIG. 5 is a perspective view of a model of a lenticular version of the lens of FIG. 3;

FIG. 6 is a side view of a plano-convex 3D lens for a full pixel design;

FIG. 7 is a side view of a convex-concave 3D lens for a full pixel design;

FIG. 8 is a diagram of a three integral imaging 3D lenses with eight views for a subpixel design;

FIG. 9 is a side view of a plano-convex 3D lens for a subpixel design;

FIG. 10 is a side view of a convex-concave 3D lens for a subpixel design; and

FIG. 11 is a top view illustrating slanted lenticulars over pixels.

### DETAILED DESCRIPTION

Embodiments of the present invention include a compound lens design that enables compact lenses for integral imaging 3D displays to produce 3D images with motion parallax. The lens design includes an outer (viewer side) convex surface and an inner (display side) concave surface registered with each other. This design enables a thinner optical component versus a singlet lens with only one curved surface with optical power. The compound lens can be fabricated as a single piece, for example in a mold, or on a substrate such as glass or plastic. The lenses can be rotationally symmetric or have translational symmetry (lenticulars) depending upon whether the integral imaging 3D display has both horizontal and vertical motion parallax or has parallax along a single axis. Standoffs or flat facets on the concave side enable the lens sheet to be adhered to the display panel and maintain an air gap between the lenses and the display glass. This design having an air gap alleviates the formation of air bubbles when attaching a flat sheet to another flat surface, in particular adhering the 3D flexible sheet to a display panel.

The plenoptic function is the link between physical objects and how they are perceived. The plenoptic function P(x,y,z,θ,φ,λ,t) is the radiance of all rays in a region of 3D space illuminated by the surrounding environment. The plenoptic function at three different points in space is represented by Pₓ, P_{y}, P_{z} for the positions x, y, z in a 3D coordinate system. An ideal display would recreate the plenoptic function at the left and right eyes at all viewing positions. An integral imaging system records and displays a subset of the plenoptic function called the lightfield, which is the radiance along rays in free space and may be recorded using a camera and a lens array.

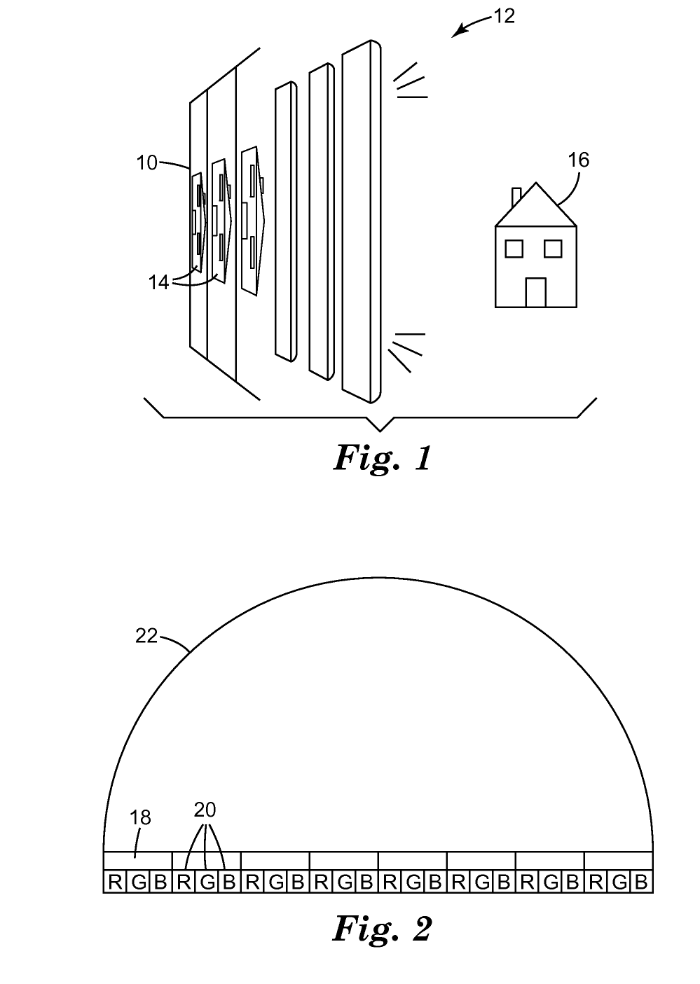

As represented in FIG. 1, a ray from a point on an object 16 strikes a specific lens 12 and is imaged onto a unique pixel on an image sensor 10. Lenses 12 can be lenticular lenses, as shown, or individual lenslets. The direction and radiance of that ray is hence encoded at that pixel. An elemental image 14 is formed behind each lens on the sensor. In an integral imaging 3D display the elemental images are displayed on a high resolution display. The same lens array used to record the integral image may be placed on top of this display. When viewed, each display pixel reproduces a ray from the scene recorded in the integral image. Each lens contributes a pixel (ray) to the image at a given viewing position. The sum of these rays is a reproduction of the scene from a given perspective. Different sets of pixels and hence different perspectives of the scene come into view from different viewing positions leading to motion parallax. The image resolution is determined by the number of lenses in the array. The number of pixels in each elemental image determines the number of views recreated by the display.

For a given display panel the integral imaging 3D image resolution and number of views is determined by the number of pixels encompassed by each lens in the array. An eight view integral imaging 3D display was designed based on a 960×640, 3.5 inch diagonal display with a 326 pixels per inch pixel density (approximately 78 microns/pixel). The base lens encompassed eight pixels and was approximately 624 microns in diameter. FIG. 2 illustrates an integral imaging lenticular 22 over eight pixels with each pixel 18 having red-green-blue (RGB) subpixel components 20.

Both lenses (8×8=64 views) and lenticulars (8 views) for horizontal motion parallax only were designed. The lenticulars were aligned parallel to the short axis of the display (landscape mode) to ensure no subpixel color breakup. The spot size of the lens at the pixel plane encompassed the full RGB pixel to ensure the subpixels were not resolved when viewing the display. This minimized any color breakup artifacts. To create a 3D image at any given position requires the left and right eyes to view distinct stereo pair images while minimizing crosstalk. For an average interpupillary distance of 63 millimeters (mm) a field of view of +/−18.245 degrees was calculated for the recommended viewing distance of 350 mm for this display. The views were divided equally over this angular region.

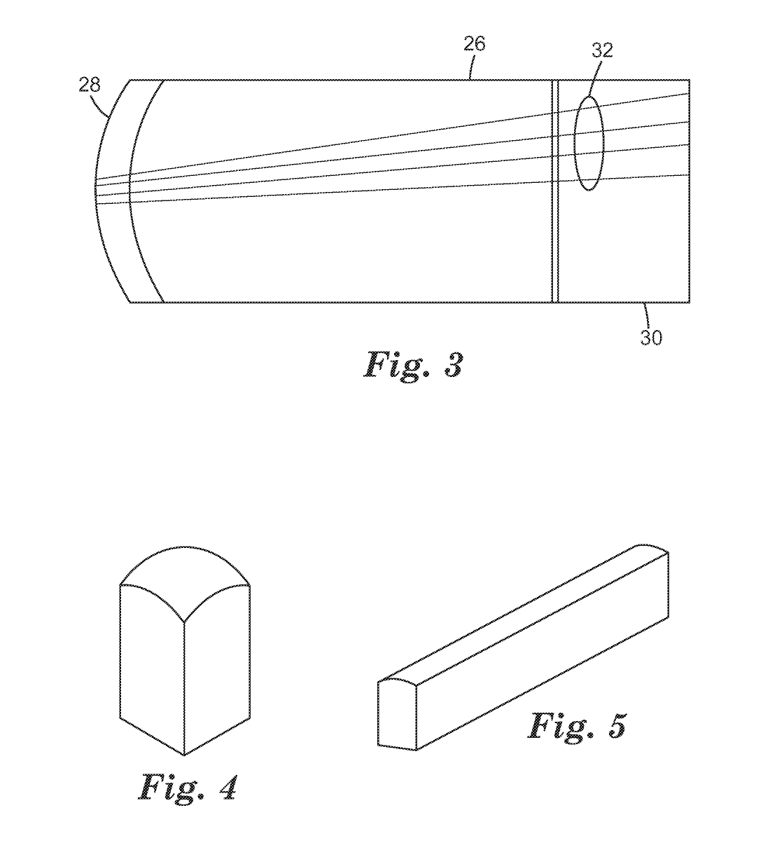

The design for a plano-convex lens that satisfies these criteria is shown in FIG. 3. Lens 26 includes a convex surface 28 opposite a display glass 30 and focuses light as represented by lines 32 for a reverse ray trace with each line corresponding with a particular view. Display glass 30 represents a display panel having pixels on a side opposite lens 26. Rays from each of the pixels emanate from lens 26 (lenticular) at the specified angle for that view. The focal plane of this lens lies in front of the pixel plane so that the individual subpixels are not resolved. An aspheric lens profile is used in this design. Lens 26 is significantly thicker than display glass 30. A significant fraction of this thickness is required to accommodate the field of view constraint described above. A solid model of this lens is shown in FIG. 4, and the lenticular version of this model is shown in FIG. 5.

The above designs were reduced to practice using compression molding and integral imaging 3D displays were demonstrated using both lens and lenticular arrays. Other designs include additional optical surfaces and other features in registration, enabling the following: film based lens arrays using high throughput manufacturing processes; thinner lenses; a lower profile (e.g., sag height) for less visible lenses; a simplified, higher yield assembly process (e.g., an easier lamination process) while minimizing air bubble defects; and improved aberration correction

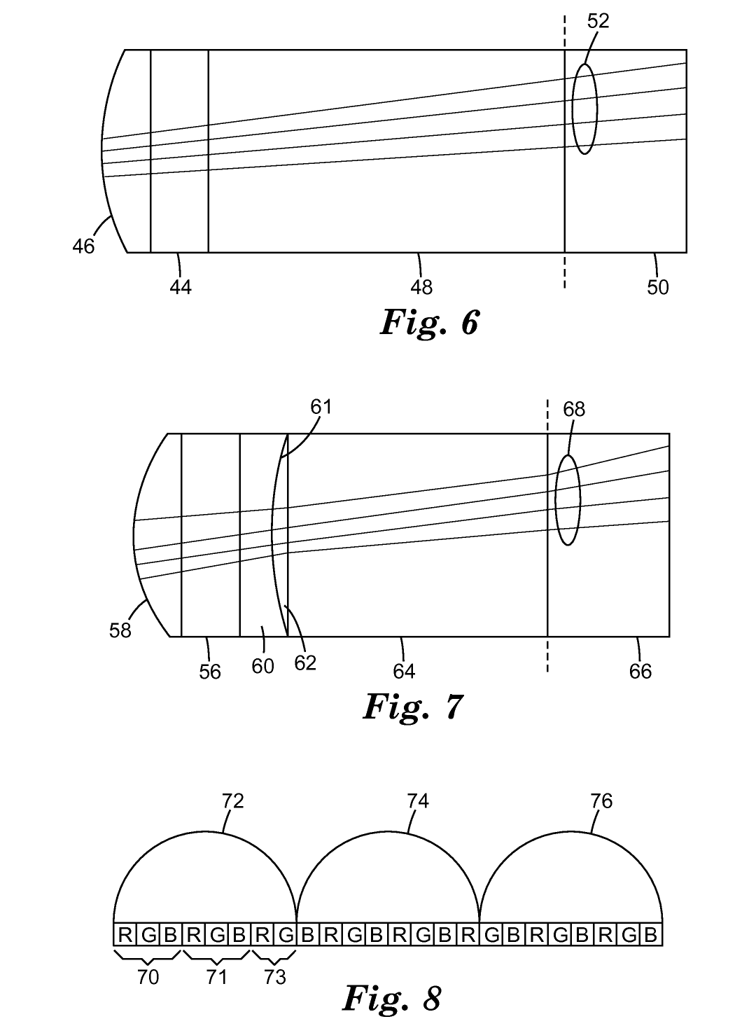

Designs for film based plano-convex and convex-concave (meniscus) lenses for an eight view integral imaging 3D display are shown in FIGS. 6 and 7, respectively. The plano-convex lens (FIG. 6) for the full pixel design includes a transmissive substrate 44 having a convex lens 46 on a viewer side, and substrate 44 is secured to a display glass 50 using an optically clear adhesive (OCA) 48. Display glass 50 represents a display panel having pixels on a side opposite the plano-convex lens. Lines 52 represent a reverse ray trace for this design with each line corresponding with a particular view.

The convex-concave lens (FIG. 7) for the full pixel design includes a transmissive substrate 56 having a convex lens 58 on a viewer side and having a concave lens 60 with a concave surface 61 on a display device side. Substrate 56 is secured to a display glass 66 using an OCA 64 and, when secured, concave lens 60 forms an air gap 62. Display glass 66 represents a display panel having pixels on a side opposite the convex-concave lens. Lines 68 represent a reverse ray trace for this design with each line corresponding with a particular view.

In the designs of FIGS. 6 and 7 the focal plane of the lenses lies behind the pixels ensuring the RGB subpixels are not resolved. In the convex-concave design of FIG. 7 the combination of air gap 62 and concave surface 61 results in an approximately 12% reduction in the overall thickness relative to the plano-convex lens of FIG. 6. The radii of curvature of the convex and concave surfaces can generally be the same or different from each other as dictated by the optical requirements. The surfaces can be spherical, aspherical, or more complex to correct for aberrations. The availability of two optical surfaces enables aberration correction. A summary of these designs is listed in Table 1.

TABLE 1

Full pixel lens design

| | Plano-Convex | | Meniscus | |
|---|---|---|---|---|
| OCA thickness | 1.1 | mm | 0.8 | mm |
| PET thickness | 7 | mil | 7 | mil |
| Total thickness | 1.4278 | mm | 1.2778 | mm |

More reductions in the thickness of the lens can be achieved with the meniscus design as the lateral dimensions of the lens decreases. The lateral dimensions can be reduced by decreasing the number of views (number of pixels under each lens), the pixel pitch, or by distributing a view over several lenses or lenticulars. The latter approach is illustrated in FIG. 8 for an eight view horizontal parallax only integral imaging 3D display.

In the conventional approach shown in FIG. 2 and described above, the eight horizontal views, each represented by a full RGB pixel, are fully enclosed within one lenticular. In the approach shown in FIG. 8 an RGB triad representing one view is distributed over three lenticulars 72, 74, and 76. Each lenticular for this one view encloses two full pixels and a partial pixel. The term partial pixel means one or more but not all subpixels of a particular pixel. Lenticular 72 encloses full RGB pixels 70 and 71, and a partial pixel 73 having only the red-green (RG) subpixel components. Lenticular 74 encloses two full RGB pixels and blue (B) and red (R) subpixel components. Lenticular 76 encloses two full RGB pixels and green-blue (GB) subpixel components. The three lenticulars 72, 74, and 76 collectively cover all eight pixels to provide one view. Since the RGB subpixels for a given view are at the same location relative to the edge of a lenticular little color divergence can be expected. A lenticular in this subpixel design encloses eight subpixels rather than eight full pixels for the full pixel design. The lateral dimension of the lenticular for the subpixel layout (see FIG. 8) is one-third that of its fulpixel counterpart (see FIG. 2). Aside from covering full pixels or full pixels plus at least one partial pixel, the lenses can be configured to cover only one or more partial pixels. For example, the lenses may each cover only two subpixels, such as if the width of lens 72 were reduced to cover only partial pixel 73.

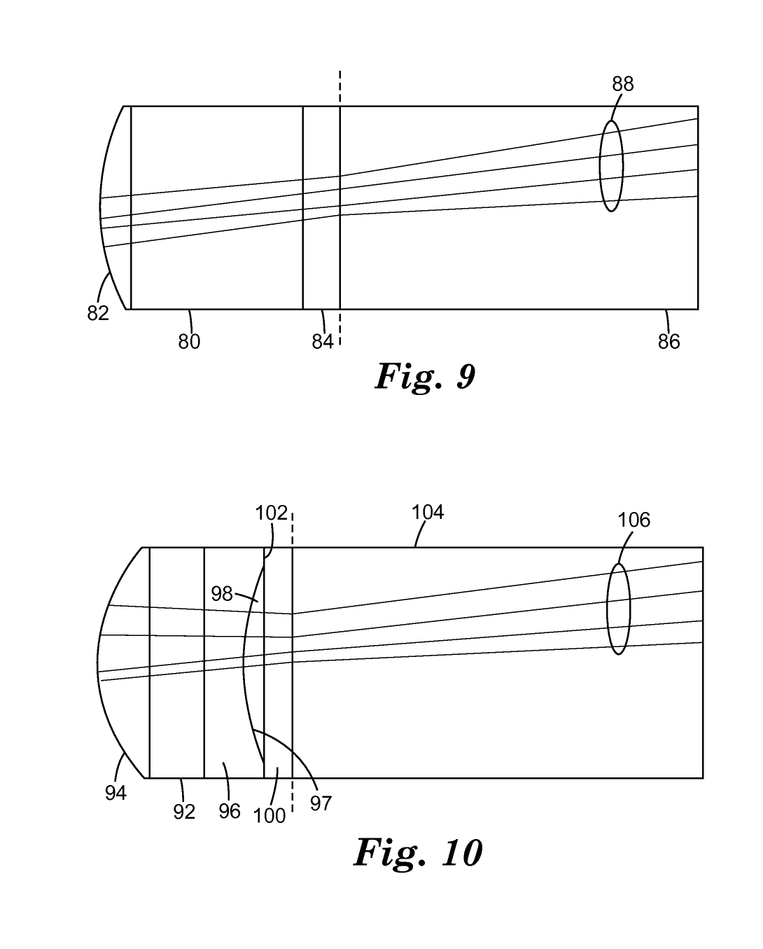

Plano-convex and meniscus lens designs for an eight view subpixel integral imaging 3D display are shown in FIGS. 9 and 10, respectively. The plano-convex lens (FIG. 9) for the subpixel design includes a transmissive substrate 80 having a convex lens 82 on a viewer side, and substrate 80 is secured to a display glass 86 using an OCA 84. Display glass 86 represents a display panel having pixels on a side opposite the plano-convex lens. Lines 88 represent a reverse ray trace for this design with each line corresponding with a particular view.

The convex-concave lens (FIG. 10) for the subpixel design includes a transmissive substrate 92 having a convex lens 94 on a viewer side and having a concave lens 96 with a concave surface 97 on a display device side. Concave lens 96 also includes flat (planar) facets 102. Substrate 92 is secured to a display glass 104 using an OCA 100 and, when secured, concave lens 96 forms an air gap 98. Flat facets 102 help secure the lenses to the glass. Display glass 104 represents a display panel having pixels on a side opposite the convex-concave lens. Lines 106 represent a reverse ray trace for this design with each line corresponding with a particular view.

The meniscus lens design of FIG. 10 is more than 46% thinner relative to the plano-convex design of FIG. 9 while satisfying all the same optical constraints. A summary of these designs is listed in Table 2.

TABLE 2

Subpixel lens design

| | Plano-Convex | | Meniscus | |
|---|---|---|---|---|
| OCA thickness | 1.5 | mil | 0.5 | mil |
| PET thickness | 7 | mil | 3 | mil |
| Total thickness | 0.2459 | mm | 0.168 | mm |

As shown in FIG. 9, the optically significant rays do not pass through the periphery of the lens. This region can be used to include additional features in the lens. For example, a flat surface or other type of mounting area can be provided at the periphery to adhere the concave side of the lens array to the display panel as shown by flat facets 102 in the design of FIG. 10. In the case of the lenticulars the concave features provide a channel for the air to escape, avoiding air bubbles while laminating the lenticular sheet to a display panel. This channel or air gap also provides an air interface at the concave surface between the lens and the panel. The reflection at this interface can decrease transmission and make the lenses more visible. This reflection can be mitigated by anti-reflection coatings at one or both of the air interfaces at the convex and concave surfaces.

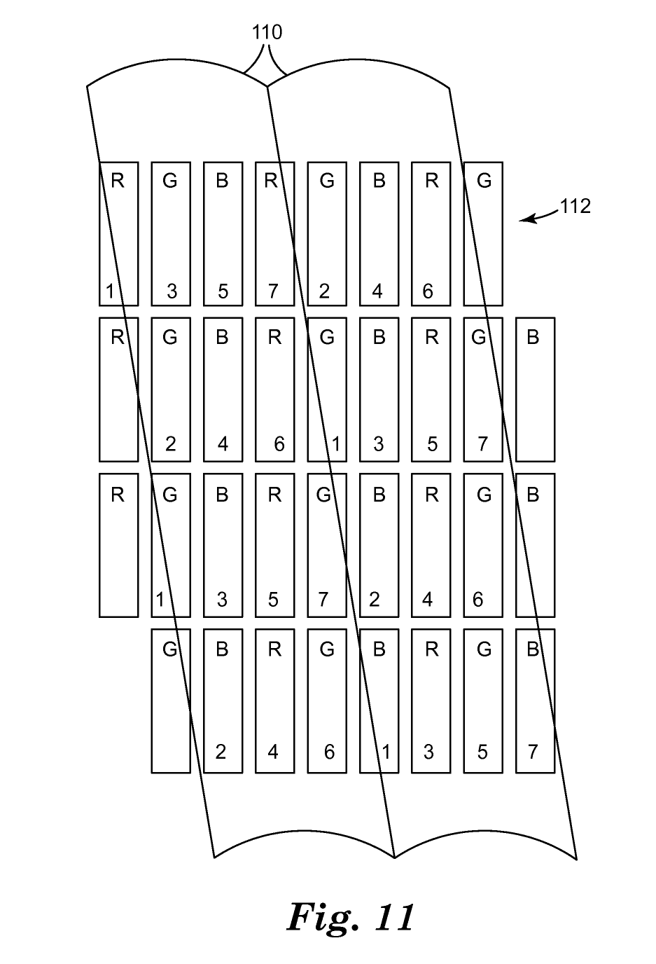

FIG. 11 is top view illustrating slanted lenticulars over pixels. In this alternative embodiment, lenticulars 110 are arranged at an angle to subpixels 112. The numbers on subpixels 112 represent specific views for the corresponding subpixels.

The following are exemplary components, materials, and design factors for implementing the integral imaging 3D articles. The substrates can be implemented with glass, quartz, polycarbonate, flexible films such as polyethylene terephthalate (PET), or other rigid or flexible transmissive materials. The substrate is transmissive in the sense it is substantially transmissive to visible light. The convex and concave lenses can be formed on the substrate from resin using a molding or microreplication process. The lenses can alternatively be formed in a monolithic structure using processes such as compression molding, injection molding, extrusion, or other replication process. In this alternative structure, the substrate is monolithic with the lenses rather than being a separate element.

The lenses can be adjacent lenticulars or lenslets, and the lenses can be, but need not be, directly adjacent one another in physical contact. The arrangement and positioning of the lenses can be determined by the locations of the corresponding pixels to be enclosed by the lenses. Software programs can be used to determine the shape of the lenses based upon a desired position of the focal plane of the lenses. The meniscus lens design of FIG. 10 can be placed directly on the display panel with an adhesive between the convex lenses and the display glass. The display panel can be implemented with a liquid crystal display (LCD) panel or other types of display panels having pixels used to generate and display content. The

Example also provides materials and components for implementing the integral imaging 3D articles.

### EXAMPLE

This Example is merely for illustrative purposes only and is not meant to be limiting on the scope of the appended claims. An eight view integral imaging 3D display was produced using the compound lens design shown in FIG. 10.

The lenticulars consisted of registered micro-replicated structures on either side of a roll of a clear three mil PET(refractive index ˜1.64) film (MELINEX 454 film from Dupont Teijin Films, Hopewell, Va., three mil thickness). The microreplicated structures were formed on the substrate from a UV curable acrylate resin (refractive index ˜1.50, 85% by weight PHOTOMER 6210 product available from IGM Resins, Inc., Bartlett, Ill., and 15% by weight 1,6-hexanedioldiacrylate available from Cytec Industries, West Paterson, N.J., and a photoinitiator 0.5% by weight LUCIRIN TPO photoinitiator, BASF Corporation, Florham Park, N.J.) using a roll based tool. The microreplication tool used for this experimental example was a metallic cylindrical tool with a lenticular one-dimensional structure. The one-dimensional structure was created by cutting into the copper surface of the cylindrical tool using a precision diamond turning machine. The resulting copper cylinder with precision lenticular cut features was chrome plated. The plating process of the copper master cylinder is used to promote release of cured resin during the microreplication process. The film replicate was made using an acrylate resin composition comprising acrylate monomers that was cast onto a PET support film and then cured against the precision patterned cylindrical tool using an LED based ultraviolet curing unit.

The substrate with the microreplicated structure was singulated from the patterned film to the size (3.5 inch diagonal) of a high resolution mobile LCD display (IPOD TOUCH 4^{th} Generation digital electronic device, Apple Inc., Cupertino, Calif.). The side with the concave features and flat facets was manually registered to the pixels and adhered to the display glass using a one mil OCA (Part number 2147, available from Soken Chemical & Engineering Co, Tokyo, Japan). The air gap between the film and adhesive enabled bubble free lamination. The narrow flat facets enabled easy rework of the part in case of misregistration.

Multiview content was generated by rendering a 3D scene from eight different perspectives, and interlacing them using POV-Ray and Processing, open source 3D rendering and programming packages (POV-Ray available from Persistence of Vision Raytracer Pty. Ltd., Williamstown, Victoria 3016, Australia and Processing available from Ben Fry, Fathom, Boston, Mass.). Multiview, glasses-free 3D was demonstrated using the lens structure and content described above.

Table 3 provides the dimensions for the integral imaging 3D film made in this Example according to the design shown in FIG. 10.

TABLE 3

| | Dimension |
|---|---|
| Feature | (mm) |
| Height of convex lens, curved portion | 0.042 |
| Height of convex lens, non-curved portion | 0.004 |
| Width of convex lens | 0.208 |
| Depth of concave lens, curved portion | 0.0184 |
| Thickness of concave lens at flat facet | 0.0284 |
| Width of concave lens, curved portion | 0.178 |
| Width of flat facet on concave lens | 0.015 |
| Thickness of adhesive | 0.0254 |
| Thickness of substrate | 0.0762 |

1. An integral imaging 3D article, comprising:
a transmissive substrate having a first surface and a second surface opposite the first surface, wherein the second surface is planar; and
a plurality of convex lenses on the first surface of the substrate, wherein the lenses are configured such that, when the second surface is placed on a display panel having pixels, the lens focus is in front of or behind the pixels.

2. The 3D article of claim 1, wherein the convex lenses comprise lenticulars.

3. The 3D article of claim 1, wherein the convex lenses comprise lenslets.

4. The 3D article of claim 1, wherein the substrate comprises a flexible film.

5. The 3D article of claim 4, wherein the convex lenses are formed from resin on the first surface.

6. The 3D article of claim 1, wherein each of the convex lenses covers only one or more full pixels.

7. The 3D article of claim 1, wherein each of the convex lenses covers at least one full pixel and at least one partial pixel.

8. The 3D article of claim 1, wherein each of the convex lenses covers only one or more partial pixels.

9. An integral imaging 3D article, comprising:
a transmissive substrate having a first surface and a second surface opposite the first surface;
a plurality of convex lenses on the first surface of the substrate; and
a plurality of concave lenses on the second surface of the substrate,
wherein the concave lenses are registered with the convex lenses,
wherein the convex and concave lenses are configured such that, when the second surface is placed on a display panel having pixels, the convex and concave lenses combined focus is in front of, at, or behind the pixels.

10. The 3D article of claim 9, wherein the convex lenses comprise lenticulars.

11. The 3D article of claim 9, wherein the convex lenses comprise lenslets.

12. The 3D article of claim 9, wherein the substrate comprises a flexible film.

13. The 3D article of claim 12, wherein the convex lenses are formed from resin on the first surface.

14. The 3D article of claim 12, wherein the concave lenses are formed from resin on the second surface.

15. The 3D article of claim 9, wherein the concave lenses include flat facets.

16. The 3D article of claim 9, wherein each of the convex and concave lenses covers only one or more full pixels.

17. The 3D article of claim 9, wherein each of the convex and concave lenses covers at least one full pixel and at least one partial pixel.

18. The 3D article of claim 9, wherein each of the convex and concave lenses covers only one or more partial pixels.

19. The 3D article of claim 9, wherein each of the convex lens and concave lens focus covers a plurality of adjacent full pixels.

20. The 3D article of claim 9, wherein each of the convex lens and concave lens focus covers a plurality of adjacent full pixels and at least one partial pixel adjacent the full pixels.

21. An integral imaging 3D device, comprising:
a display panel having pixels; and
a 3D article on a surface of the display panel, wherein the 3D article comprises:
a transmissive substrate having a first surface and a second surface opposite the first surface;
a plurality of convex lenses on the first surface of the substrate; and
a plurality of concave lenses on the second surface of the substrate,
wherein the concave lenses are registered with the convex lenses,
wherein the convex and concave lenses combined focus is in front of, at, or behind the pixels.

22. The 3D device of claim 21, wherein the concave lenses are secured with an adhesive directly on the surface of the display panel.

23. The 3D device of claim 21, wherein the concave lenses include flat facets.

24. The 3D article of claim 21, wherein each of the convex and concave lenses covers at least one full pixel and at least one partial pixel.

25. The 3D article of claim 21, wherein each of the convex and concave lenses covers only one or more partial pixels.

26. The 3D device of claim 21, wherein the convex and concave lenses are slanted with respect to the pixels.
